(19) United States
(12) Patent Application Publication
(10) Pub. No.: US 2026/0094308 A1
(43) Pub. Date: Apr. 2, 2026

(54) REMOVING DISTRIBUTIONAL DISCREPANCIES IN CAPTIONS FOR IMAGE-TEXT ALIGNMENT

(71) Applicant: ADOBE INC., SAN JOSE, CA (US)

(72) Inventors: Yuheng Li, San Jose, CA (US); Krishna Kumar Singh, San Jose, CA (US); Yijun Li, Seattle, WA (US); Elya Shechtman, Seattle, WA (US); Zhe Lin, Clyde Hill, WA (US)

(21) Appl. No.: 18/899,996

(22) Filed: Sep. 27, 2024

(51) Int. Cl. G06T 11/00; G06T 5/70; G06T 9/00

(52) U.S. Cl. CPC G06T 11/00; G06T 5/70; G06T 9/00; G06T 2207/20081; G06T 2207/20084

(57) ABSTRACT

A method, apparatus, non-transitory computer readable medium, and system for text generation includes obtaining an input image including a first element having a first value of an attribute and a second element having a second value of the attribute. An image encoder of a multi-modal machine learning model then encodes the input image to obtain an image embedding and a text decoder of the multi-modal machine learning model generates an output text based on the image embedding. The output text indicates that the first element has the first value of the attribute and that the second element has the second value of the attribute.

### BACKGROUND

The following relates generally to image processing, and more specifically to image-text alignment. In some cases, machine learning models may function as encoders by generating a vector representation of an input. Multi-modal encoders are specialized machine learning models that are trained to generate vector representations of inputs from different modalities (e.g., a text input and an image input) such that the different vector representations may be aligned with each other across different modalities.

Multi-modal encoders may be used in text-based tasks to identify a vector representation of an image that aligns with the text input. However, conventionally used multi-modal encoders do not effectively perform compositional reasoning or are unable to process complex sentence prompts. Therefore, such models are unable to accurately align different modalities (e.g., a text and corresponding images) for a wide range of user input.

### SUMMARY

Systems and methods are described for image-text alignment. Embodiments of the present disclosure include a multi-modal machine learning model configured to generate a training dataset for performing the image-text alignment. In some cases, the training dataset includes an image-text pair comprising a training image and a corresponding positive training text (e.g., a positive caption that describes the training image). According to an embodiment, the multi-modal machine learning model generates a negative training text based on modifying the positive training text. An embodiment of the present disclosure includes fine-tuning the multi-modal machine learning model based on filtering the training dataset to ensure consistency between positive and negative caption distributions.

A method, apparatus, and non-transitory computer readable medium for image processing are described. One or more aspects of the method, apparatus, and non-transitory computer readable medium include obtaining preliminary training data including a positive training pair comprising a training image that depicts a scene and a training text that describes the scene; filtering the preliminary training data based on an alignment score threshold to obtain a filtered training set, wherein the preliminary training data is filtered by comparing an alignment score of the positive training pair to the alignment score threshold; and training, using the filtered training set, the multi-modal machine learning model to encode the training image and the training text.

A method, apparatus, and non-transitory computer readable medium for image processing are described. One or more aspects of the method, apparatus, and non-transitory computer readable medium include obtaining an input image including a first element having a first value of an attribute and a second element having a second value of the attribute; encoding, using an image encoder of a multi-modal machine learning model, the input image to obtain an image embedding; and generating, using a text decoder of the multi-modal machine learning model, an output text based on the image embedding, wherein the output text indicates that the first element has the first value of the attribute and that the second element has the second value of the attribute.

An apparatus, system, and method for image processing are described. One or more aspects of the apparatus, system, and method include at least one processor; at least one memory component coupled with the at least one processor; and a multi-modal machine learning model comprising parameters stored in the at least one memory component, wherein the multi-modal machine learning model comprises a text encoder trained to encode an input text and an image encoder trained to encode an input image, and wherein the multi-modal machine learning model is trained based on a filtered training set that is obtained by comparing an alignment score of a training pair to an alignment score threshold.

### BRIEF DESCRIPTION OF THE DRAWINGS

FIG. 1 shows an example of an image processing system according to aspects of the present disclosure.

FIG. 2 shows an example of a method for generating an image according to aspects of the present disclosure.

FIG. 3 shows an example of an image sorting process according to aspects of the present disclosure.

FIG. 4 shows an example of a latent diffusion architecture according to aspects of the present disclosure.

FIG. 5 shows an example of a U-net architecture according to aspects of the present disclosure.

FIG. 6 shows an example of a diffusion denoising process according to aspects of the present disclosure.

FIG. 7 shows an example of a method for image processing according to aspects of the present disclosure.

FIG. 8 shows an example of an image alignment process according to aspects of the present disclosure.

FIG. 9 shows an example of a method for image processing according to aspects of the present disclosure.

FIG. 10 shows an example of a method of training a machine learning model according to aspects of the present disclosure.

FIG. 11 shows an example of a method of training a diffusion model according to aspects of the present disclosure.

FIG. 12 shows an example of a computing device according to aspects of the present disclosure.

FIG. 13 shows an example of an image processing apparatus according to aspects of the present disclosure.

FIG. 14 shows an example of a multi-modal machine learning model according to aspects of the present disclosure.

### DETAILED DESCRIPTION

The present disclosure describes systems and methods for image processing. In some cases, a multi-modal machine learning model of the present disclosure generates an image that accurately aligns with each aspect of an input prompt (e.g., a complex sentence prompt provided by a user). In some cases, the multi-modal machine learning model of the present disclosure generates a text (e.g., a caption) that accurately describes a scene depicted in an input image (e.g., an image depicting a scene with multiple objects and attributes).

Machine learning models may be used for text to image generation tasks based on a vector representation of an input prompt that matches a vector representation of an image. However, existing machine learning models face difficulties in handling compositional reasoning or complex sentence prompts. Thus, existing machine learning models are unable to provide accurate images that align with user provided input prompts.

For example, existing machine learning models are unable to comprehend simple sentences, such as existing machine learning models do not have an ability to distinguish between simple sentences as “horse eating grass” and “grass eating horse”. Moreover, in some examples, a conventional approach to training the machine learning model includes generating random negative captions, i.e., captions that are not aligned with the images, and pairing such randomly generated negative captions with training image-text pairs. Such approaches may lead to distributional biases in the dataset resulting in inaccurate predictions by the machine learning model.

By contrast, systems and methods are described for image-text alignment. Embodiments of the present disclosure include a multi-modal machine learning model configured to generate a training dataset for performing the image-text alignment. In some cases, the training dataset includes an image-text pair comprising a training image and a positive training text. According to an embodiment, the multi-modal machine learning model generates a negative training text based on modifying the positive training text. An embodiment of the present disclosure includes fine-tuning the multi-modal machine learning model based on filtering the training dataset to ensure consistency between positive and negative caption distributions.

A multi-modal machine learning model of the present disclosure generates accurate images even when processing complex sentence prompts. The multi-modal machine learning model includes a transformer model that is configured to generate different types of negative captions using a positive caption during the training process. In some cases, the transformer model generates negative captions based on a replacing operation (i.e., where a linguistic element is substituted with an arbitrary element). For instance, in case of a positive caption such as “a knife is one the table”, the transformer model generates an associated negative caption as “a spoon is on the table”.

Additionally or alternatively, the transformer model generates negative captions based on a swapping operation (i.e., where words within the same sentence are rearranged). For instance, in case of a positive caption such as “an apple is to the left of a banana”, the transformer model generates a negative caption “a banana is to the left of an apple”. Accordingly, by training the multi-modal machine learning model using challenging negative captions (i.e., captions that are very similar to the positive caption), embodiments of the present disclosure are able to enhance the reasoning capabilities of the machine learning model.

An embodiment of the present disclosure is configured to ensure consistency between the positive captions and the negative captions at the distribution level. In some cases, the machine learning model of the present disclosure includes a binary classifier that is configured to prevent dataset-level distribution differences. In some cases, the binary classifier is fine-tuned on text captions which results in removal of biased data such that the fine-tuned classifier can accurately perform a prediction with high confidence. For example, the binary classifier is trained on text to predict positive and negative captions, such that the captions which can be predicted by high confidence using the binary classifier are not used for training the multi-modal machine learning model since the binary classifier does not need to see the image.

Embodiments of the present disclosure include a multi-modal machine learning model configured to perform an image-text alignment. In some cases, the machine learning model identifies dataset-level distribution differences between positive and negative captions that lead to biased image-text alignment models. In some cases, the machine learning model ensures consistency between positive and negative caption distributions. As a result, the machine learning model relies on both image and text to measure alignment (i.e., instead of only biases present in the text).

An embodiment of the present disclosure is configured to generate curated training data for fine-tuning the binary classifier for image-text alignment. In some cases, the curated training data is generated by removing the biased positive and negative captions which ensures the machine learning model relies on both image and text to measure alignment. In some examples, the trained machine learning model is configured to rank images generated based on an input text prompt. For example, the trained machine learning model ranks the images based on the alignment with the input text.

Accordingly, by generating negative training text based on the positive training text, embodiments of the present disclosure are able to reduce a distribution imbalance between the positive training text and the negative training text which ensures that the image-text alignment is based on both, the images and associated text, instead of solely relying on textual information. Additionally, by generating the enhanced and filtered training dataset, embodiments provide a machine learning model that incudes an improved image-text alignment and can provide images that are accurately aligned with the text input.

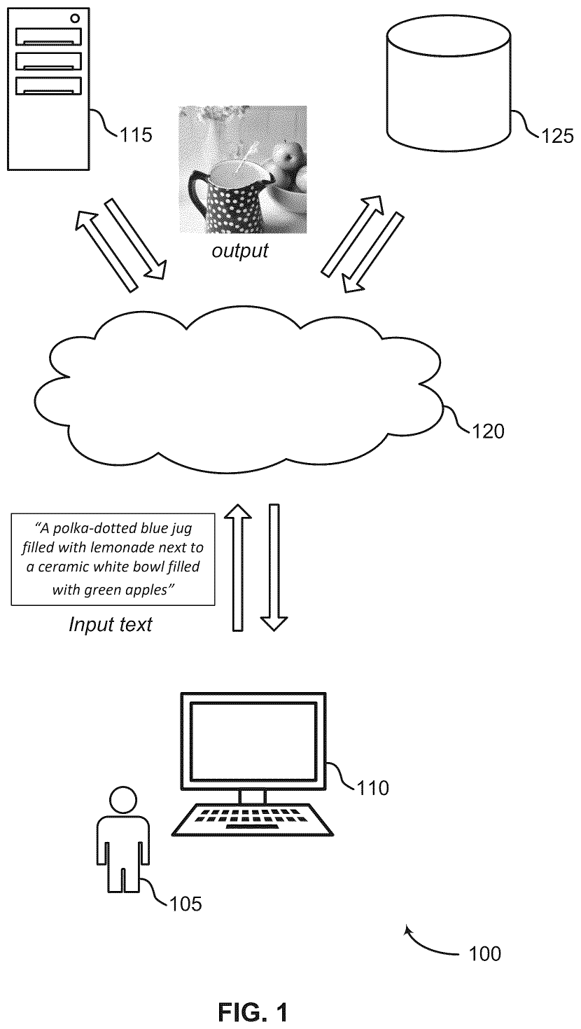

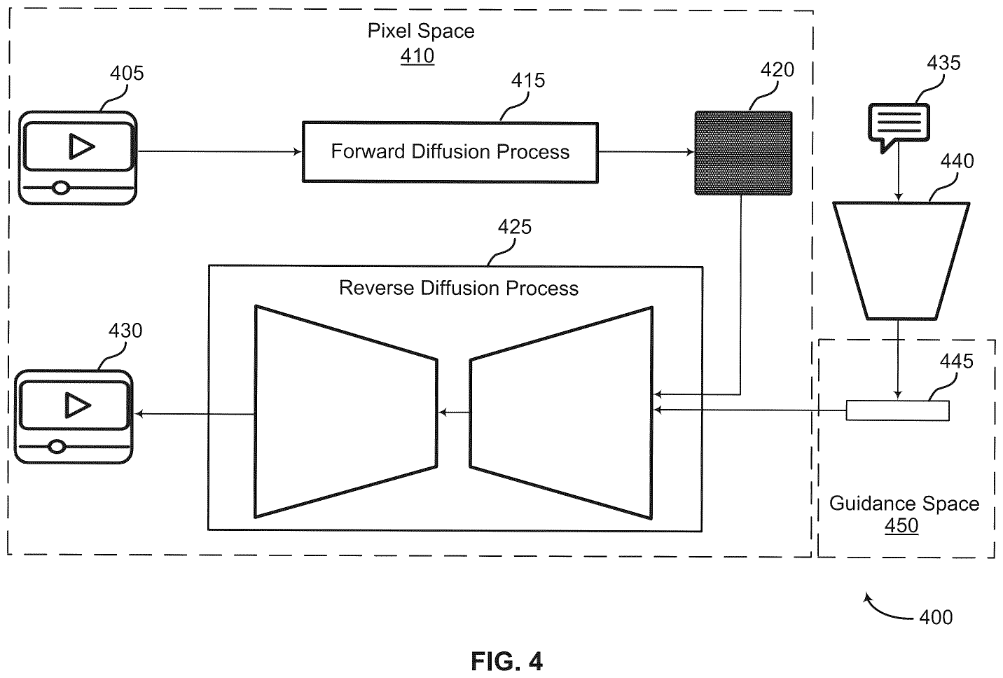

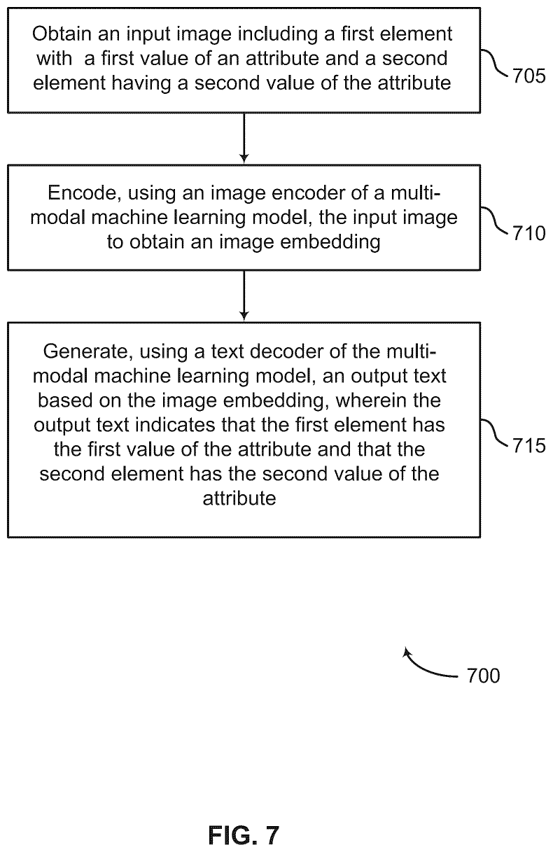

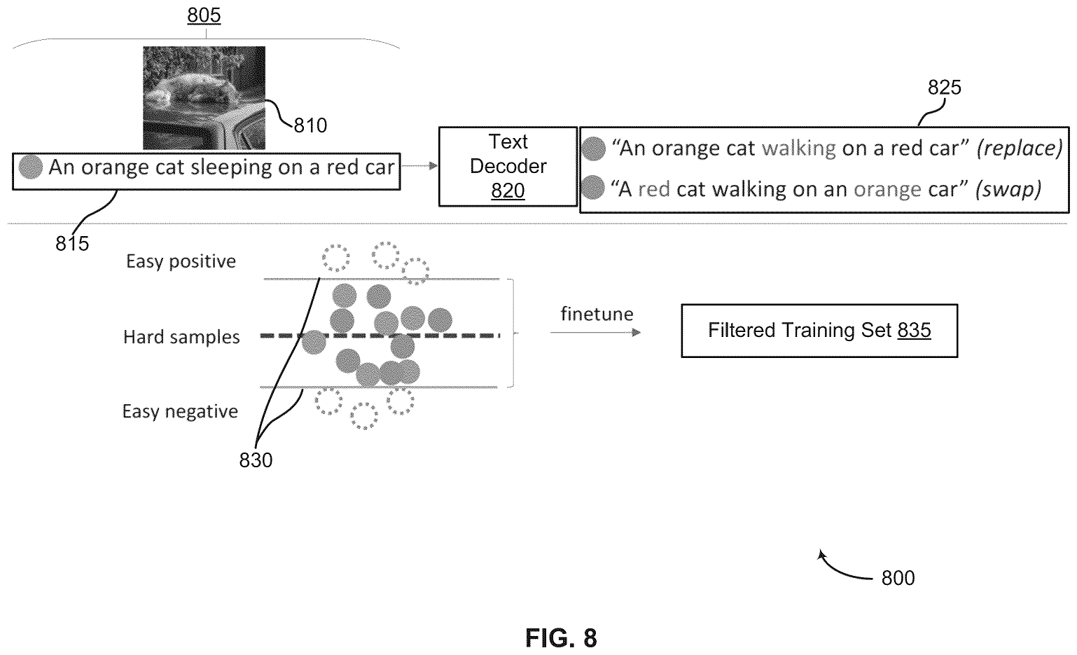

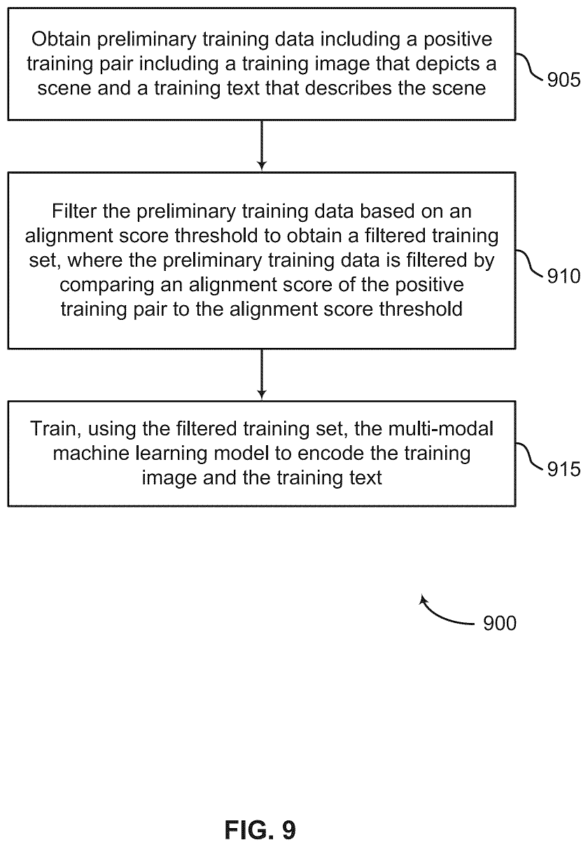

Embodiments of the present disclosure can be implemented in a text-to-image generation model. For example, the multi-modal machine learning model based on the present disclosure takes an input text (e.g., describing a scene) and accurately generates an image that correctly depicts the content in the input text. Example applications regarding generating an image that depicts a scene are provided with reference to FIGS. 1-3. Details regarding the architecture of the multi-modal machine learning model are provided with reference to FIGS. 4-6 and 12-14. Details regarding a process of operation of the multi-modal machine learning model are provided with reference to FIGS. 7-8. Examples of a process for training the multi-modal machine learning model are provided with reference to FIGS. 9-11.

### Image Generation System

A system and an apparatus for image processing are described with reference to FIGS. 1-6. FIG. 1 shows an example of an image processing system 100 according to aspects of the present disclosure. In one aspect, image processing system 100 includes user 105, user device 110, image processing apparatus 115, cloud 120, and database 125.

In the example of FIG. 1, user 105 provides an input prompt to image processing apparatus 115 via a user interface provided on user device 110 by image processing apparatus 115. In some cases, the input prompt is an input text. As used herein, the input text describes a scene that the user wants to depict in a generated image. As an example shown in FIG. 1, the user provides an input text that describes the scene the user wants to generate using the image processing apparatus 115 of the present disclosure. According to some aspects, image processing apparatus 115 obtains an input prompt, i.e., description of a scene (e.g., “a polka dotted blue jug filled with lemonade next to a ceramic white bowl filled with green apples”).

In some cases, the image processing apparatus 115 implements an image-text alignment model (such as based on the image-text alignment process described with reference to FIGS. 7-8) to generate a synthetic image based on the input prompt. In some cases, as shown in FIG. 1, the user provides an input prompt (e.g., a text prompt) to the image processing apparatus 115, aspects of which the user wants to depict in a synthetic image (i.e., output image). In some examples, the image processing apparatus generates a synthetic image that accurately depicts the scene described in the input prompt. For example, as shown in FIG. 1, the image processing apparatus generates an output (i.e., a synthetic image) that depicts a polka-dotted blue jug filled with lemonade next to a ceramic white bowl filled with green apples.

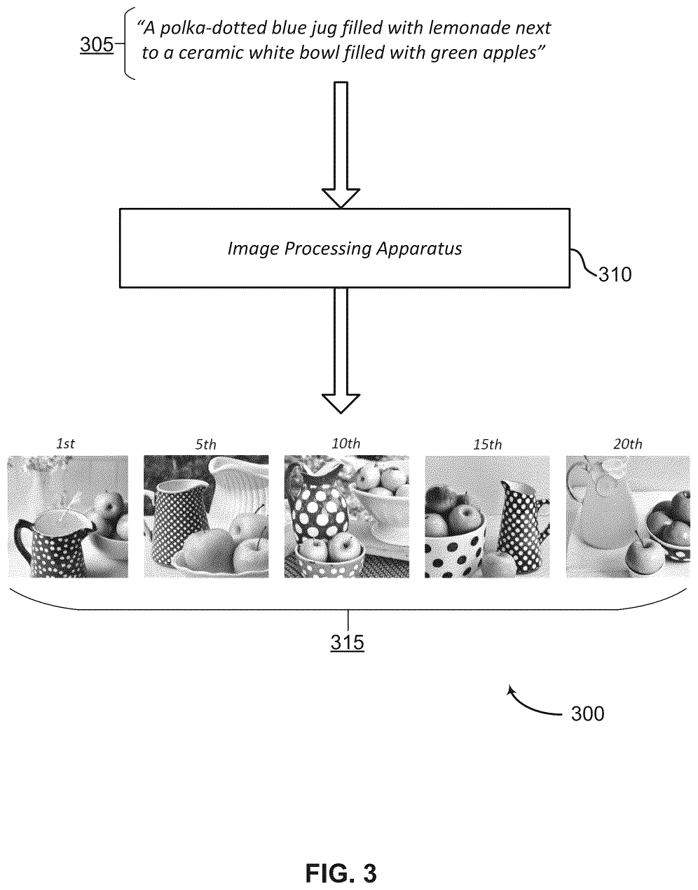

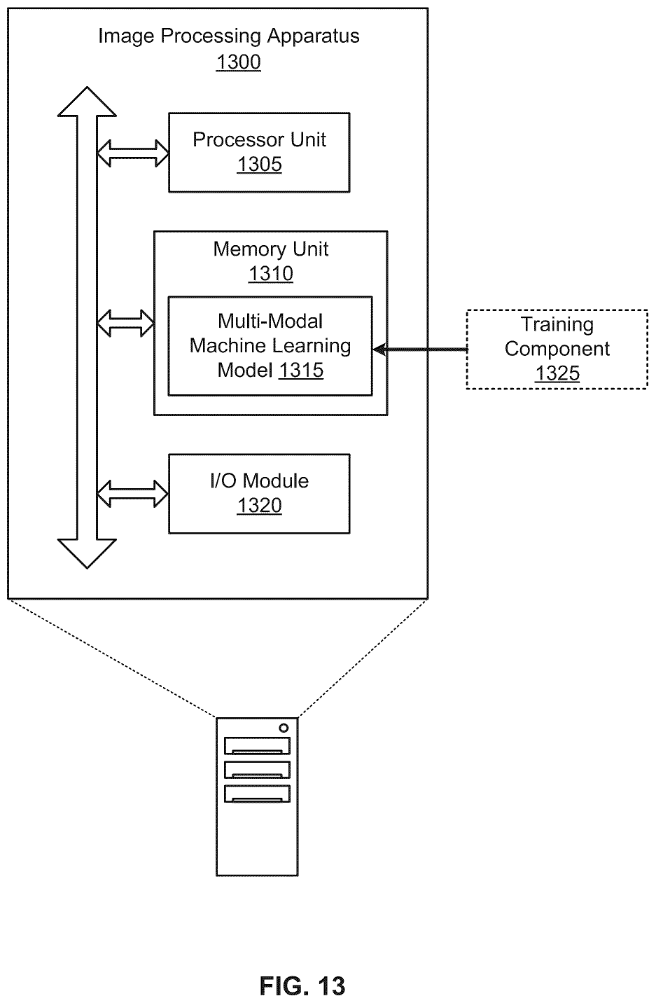

Referring to the example of FIG. 1, the image processing apparatus 115 provides the synthetic image to user 105 via the user interface provided on user device 110. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a prompt, etc.) to be communicated between user 105 and image processing apparatus 115. Image processing apparatus 115 is an example of, or includes aspects of, the corresponding element described with reference to FIGS. 3 and 13.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

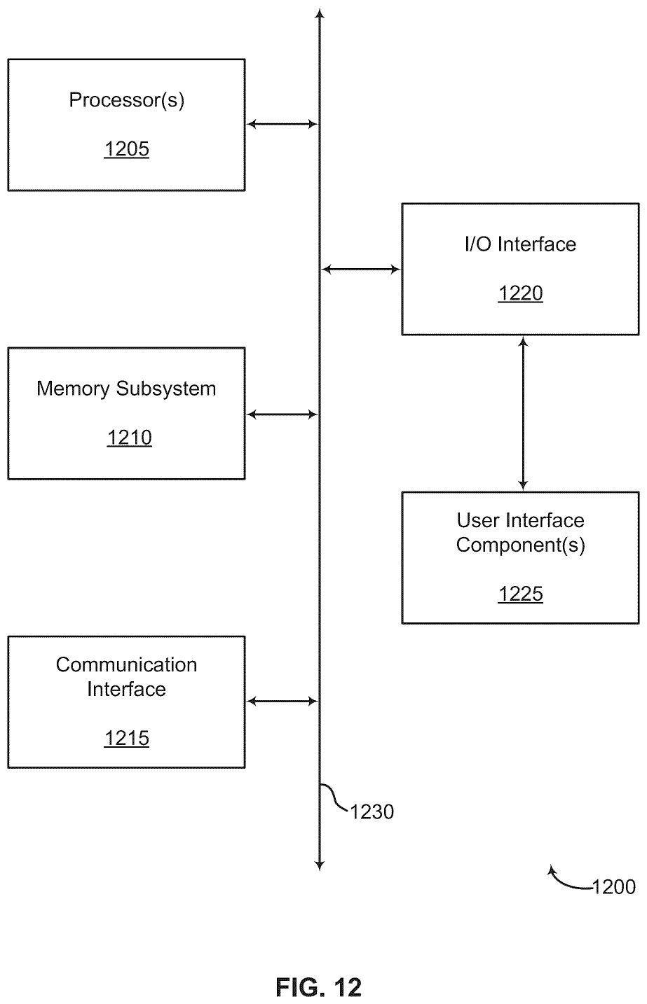

According to some aspects, image processing apparatus 115 includes a computer-implemented network. In some embodiments, the computer-implemented network includes a machine learning model (such as the machine learning model described with reference to FIGS. 7 and 8). In some embodiments, image processing apparatus 115 also includes one or more processors, a memory subsystem, a communication interface, an I/O interface, one or more user interface components, and a bus as described with reference to FIG. 12. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

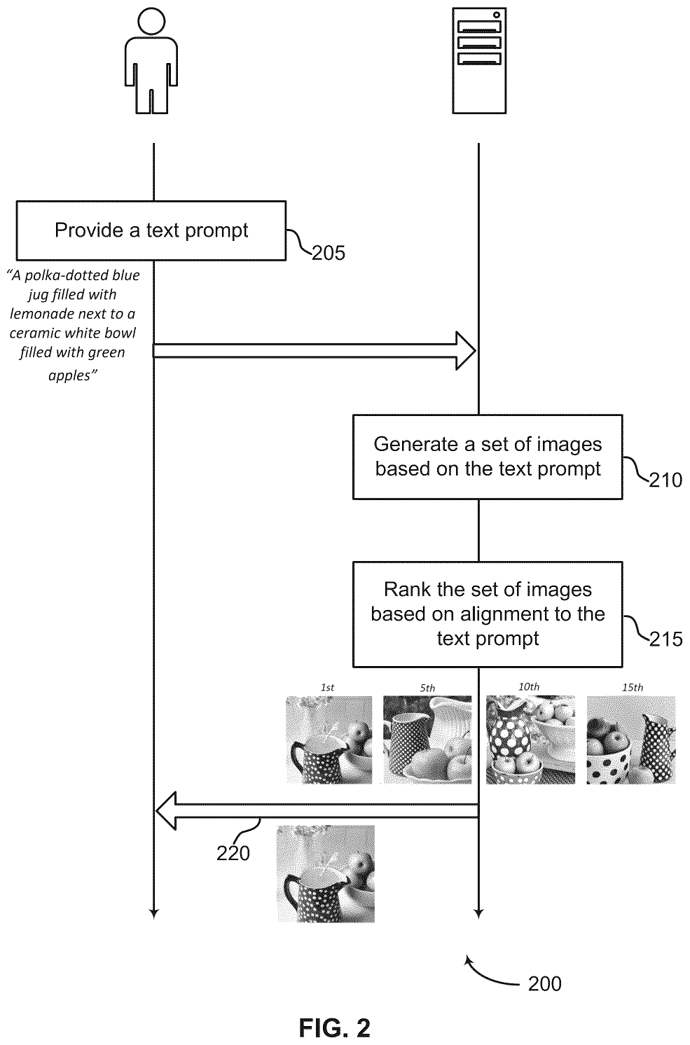

FIG. 2 shows an example of a method 200 for generating an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to an embodiment of the present disclosure, an image processing apparatus (such as the image processing apparatus described with reference to FIG. 3) provides a machine learning model (such as the machine learning model described with reference to FIGS. 7-9) that accurately generates a synthetic image depicting a scene described in an input text prompt.

At operation 205, the system provides a text prompt. In some cases, the operations of this step refer to, or may be performed by, a user as described with reference to FIG. 1.

In some examples, the user provides a text prompt to the image processing apparatus (such as the image processing apparatus described with reference to FIG. 1). As shown in FIG. 2, the text prompt describes a scene that the user wants to generate an image for. For example, the user wants the synthetic (i.e., output) image to include an image of the “polka dotted jug” as specified in the text prompt. In some cases, the user provides the text prompt to the image processing apparatus via a user interface (such as a graphical user interface) provided on a user device by the image processing apparatus.

At operation 210, the system generates a set of images based on the text prompt. In some cases, the operations of this step refer to, or may be performed by, an image processing apparatus as described with reference to FIGS. 3 and 13. In some cases, the image processing apparatus generates a plurality of images based on the text prompt. In some examples, the image processing apparatus uses a diffusion model to perform text-to-image generation. Further details regarding this operation are provided with reference to FIGS. 4-7.

At operation 215, the system ranks the set of images based on alignment to the text prompt. In some cases, the operations of this step refer to, or may be performed by, an image processing apparatus as described with reference to FIGS. 1, 3, and 13.

According to an embodiment, the image processing apparatus generates a training negative caption based on a training positive caption. Additionally, the image processing apparatus identifies a dataset-level distribution difference between input text, i.e., the positive text caption and the negative text caption (such as the positive and negative captions described with reference to FIGS. 7-8). In some cases, the image processing apparatus is configured to maintain consistency between the distribution of the positive and negative captions.

In some examples, the image processing apparatus implements a filtering operation for image-text alignment. In some cases, the image processing apparatus of the present disclosure is able to rank the images generated by a multi-modal machine learning model (such as the machine learning model described with reference to FIGS. 7-8 and 13-14) of the image processing apparatus. For example, as shown with reference to operation 215 in FIG. 2, the image processing apparatus ranks a plurality of generated images (such as the images generated at operation 210) based on the alignment with the input prompt (such as the input prompt received from the user at operation 205).

At operation 220, the system displays the highest ranked image to the user. In some cases, the operations of this step refer to, or may be performed by, an image processing apparatus as described with reference to FIGS. 1 and 12.

Embodiments of the present disclosure include an image processing apparatus configured to perform a mitigation of differences in dataset-level distribution. For example, embodiments are able to reduce the distribution differences between positive and negative captions (such as using the process described in FIGS. 7-8) that result in an unbiased machine learning model (such as the machine learning model described with reference to FIGS. 7-8 and 13-14). The machine learning model is, thus, able to accurately generate the image based on the input text prompt.

For example, the displayed image accurately depicts the polka-dotted blue jug filled with lemonade next to a ceramic white bowl filled with green apples, as described in the input prompt. For example, in some cases, the image processing apparatus displays the synthetic image to the user via the user interface (such as the user interface described with reference to FIG. 1).

However, embodiments are not necessarily limited thereto and in some exemplary cases, the user provides an input image (e.g., depicting a scene comprising an element) for generating a text prompt that accurately describes the scene. Accordingly, in such cases, the user provides the input image to the image processing apparatus via a user interface (such as a graphical user interface) provided on a user device by the image processing apparatus. The image processing apparatus then encodes the input image to generate an image embedding. In some cases, the image embedding is used to generate an output text that describes aspects of the input image. For example, the output text accurately aligns with the scene of the input image. Further details regarding the generation of the output text are provided with reference to FIG. 7.

FIG. 3 shows an example of an image sorting process 300 according to aspects of the present disclosure. In one aspect, image sorting process 300 includes input text 305, image processing apparatus 310, and sorted images 315.

Referring to FIG. 3, input text 305 describes a scene a user wants to depict in an image. In some cases, input text includes specific aspects of an element (or a plurality of elements). For instance, the input prompt 305 specifies a specific attributes (such as color and style e.g., “polka-dotted blue” or “ceramic white”) of the elements “jug” and “bowl” and additional attributes such as the elements are filled with lemonade and green apples, respectively. Input prompt 305 is an example of, or includes aspects of, the corresponding element described with reference to FIG. 8.

As shown in FIG. 3, the image processing apparatus 310 (such as the image processing apparatus described with reference to FIGS. 1, 2, and 13-14) receives input prompt 305 from the user. In some cases, the image processing apparatus 310 generates a set of images that follow the description provided by the input prompt 305. Additionally, the image processing apparatus 310 ranks the generated set of images based on the alignment to the input prompt 305 to generate sorted images 315. Sorted images 315 are an example of, or include aspects of, the corresponding element described with reference to FIG. 2.

In some examples, as shown in FIG. 3, the image ranked 1^{st}, i.e., among sorted images 315, by the image processing apparatus accurately describes the text prompt. That is, the image ranked 1^{st} correctly depicts “A polka-dotted blue jug filled with lemonade next to a ceramic white bowl filled with green apples”. Further, as shown in FIG. 3, the image ranked 5^{th} among the sorted images 315 accurately depicts “A polka-dotted blue jug next to a ceramic white bowl filled with green apples”. However, the said image does not show the polka-dotted blue jug as being filled with lemonade. Thus, an image with a lower rank does not align completely with the input prompt. As such, the images are ranked based on the alignment with respect to the input prompt and a low ranked image (such as image ranked 20^{th}) depicts a poor alignment with the input prompt 305. Image processing apparatus 310 is an example of, or includes aspects of, the corresponding element described with reference to FIGS. 1 and 13.

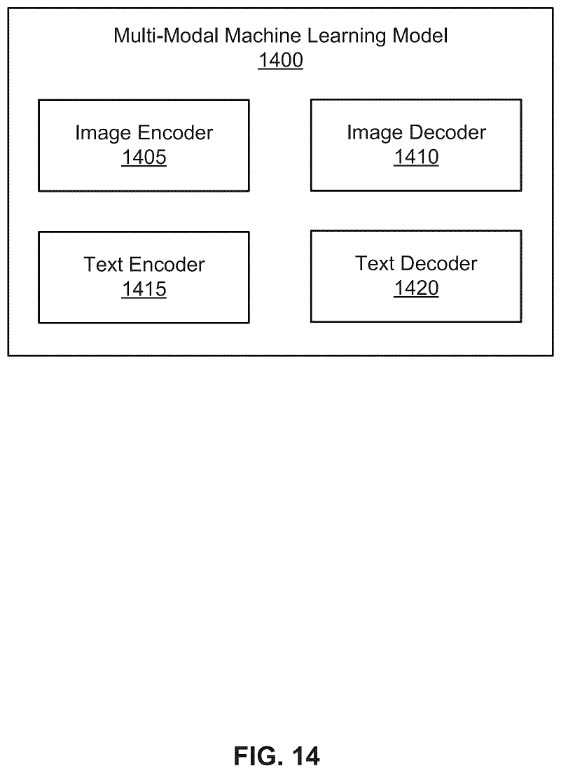

FIG. 4 shows an example of a guided diffusion model 400 according to aspects of the present disclosure. In some examples, guided diffusion model 400 describes the operation and architecture of the machine learning model 1315 described with reference to FIG. 13 or machine learning model 1400 described with reference to FIG. 14. The guided latent diffusion model 400 depicted in FIG. 4 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 400 may take an original media item 405 in a pixel space 410 as input and apply forward diffusion process 415 to gradually add noise to the original media item 405 to obtain noisy media item 420 at various noise levels.

Next, a reverse diffusion process 425 (e.g., a U-Net) gradually removes the noise from the noisy media item 420 at the various noise levels to obtain an output media item 430. In some cases, an output media item 430 is created from each of the various noise levels. The output media item 430 can be compared to the original media item 405 to train the reverse diffusion process 425.

The reverse diffusion process 425 can also be guided based on a text prompt 435, or another guidance prompt, such as an image, a layout, a segmentation map, etc. The text prompt 435 can be encoded using a text encoder 465 (e.g., a multimodal encoder) to obtain guidance features 445 in guidance space 450. The guidance features 445 can be combined with the noisy media item 420 at one or more layers of the reverse diffusion process 425 to ensure that the output media item 430 includes content described by the text prompt 435. For example, guidance features 445 can be combined with the noisy features using a cross-attention block within the reverse diffusion process 425.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 2, 5, 6, and 10-12.

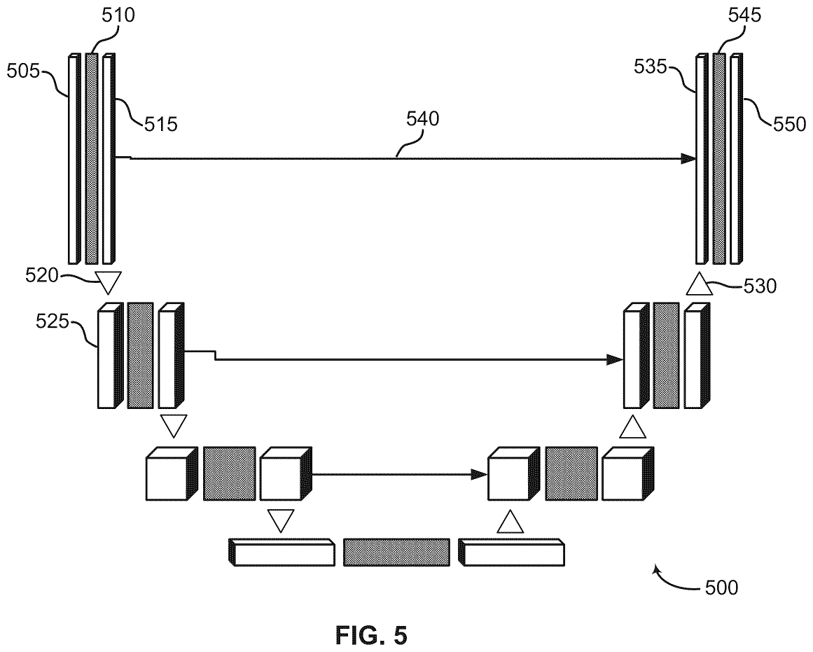

FIG. 5 shows an example of a U-Net 500 according to aspects of the present disclosure. In some examples, U-Net 500 is an example of the component that performs the reverse diffusion process 425 of guided diffusion model 400 described with reference to FIG. 4 and includes architectural elements of the machine learning model 1315 described with reference to FIG. 13 or machine learning model 1400 described with reference to FIG. 14. The U-Net 500 depicted in FIG. 5 is an example of, or includes aspects of, the architecture used within the reverse diffusion process described with reference to FIG. 4.

In some examples, diffusion models are based on a neural network architecture known as a U-Net. The U-Net 500 takes input features 505 having an initial resolution and an initial number of channels and processes the input features 505 using an initial neural network layer 510 (e.g., a convolutional network layer) to produce intermediate features 515. The intermediate features 515 are then down-sampled using a down-sampling layer 520 such that down-sampled features 525 features have a resolution less than the initial resolution and a number of channels greater than the initial number of channels.

This process is repeated multiple times, and then the process is reversed. That is, the down-sampled features 525 are up-sampled using up-sampling process 530 to obtain up-sampled features 535. The up-sampled features 535 can be combined with intermediate features 515 having the same resolution and number of channels via a skip connection 540. These inputs are processed using a final neural network layer 545 to produce output features 550. In some cases, the output features 550 have the same resolution as the initial resolution and the same number of channels as the initial number of channels.

In some cases, U-Net 500 takes additional input features to produce conditionally generated output. For example, the additional input features could include a vector representation of an input prompt. The additional input features can be combined with the intermediate features 515 within the neural network at one or more layers. For example, a cross-attention module can be used to combine the additional input features and the intermediate features 515. U-Net architecture is an example of, or includes aspects of, the corresponding element described with reference to FIGS. 2, 4, 6, and 10-12.

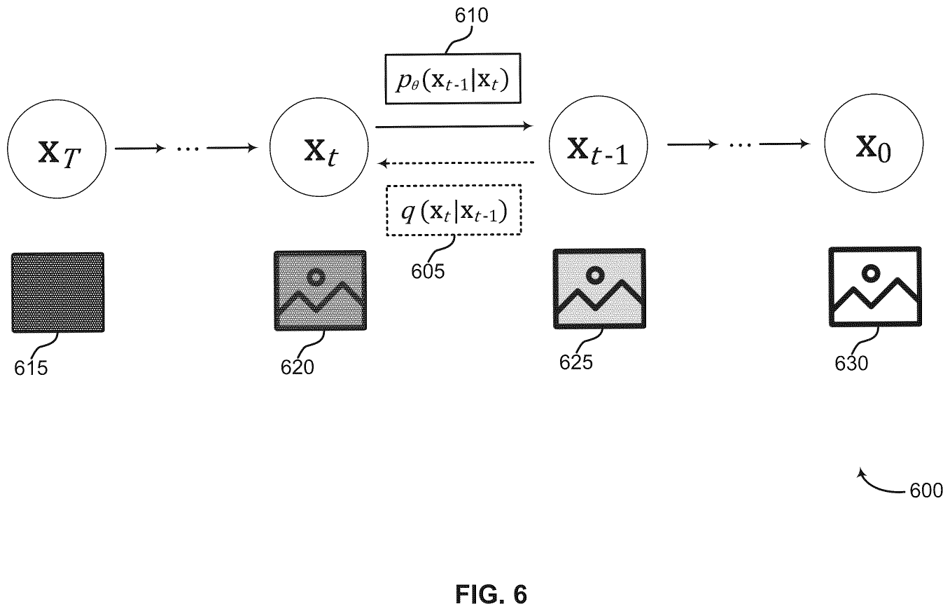

FIG. 6 shows a diffusion process 600 according to aspects of the present disclosure. In some examples, diffusion process 600 describes an operation of the machine learning model 1315 described with reference to FIG. 13 or machine learning model 1400 described with reference to FIG. 14, such as the reverse diffusion process 425 of guided diffusion model 400 described with reference to FIG. 4.

As described above with reference to FIG. 4, using a diffusion model can involve both a forward diffusion process 605 for adding noise to a media item (or features in a latent space) and a reverse diffusion process 610 for denoising the media item (or features) to obtain a denoised media item. The forward diffusion process 605 can be represented as q(xₜ|xₜ₋₁), and the reverse diffusion process 610 can be represented as p(xₜ₋₁|xₜ). In some cases, the forward diffusion process 605 is used during training to generate media items with successively greater noise, and a neural network is trained to perform the reverse diffusion process 610 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 610, the model begins with noisy data x_{T}, such as a noisy media item 615 and denoises the data to obtain the p(xₜ₋₁|xₜ). At each step t−1, the reverse diffusion process 610 takes xₜ, such as first intermediate media item 620, and t as input. Here, t represents a step in the sequence of transitions associated with different noise levels, The reverse diffusion process 610 outputs xₜ₋₁, such as second intermediate media item 625 iteratively until x_{T} reverts back to x₀, the original media item 630. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t - 1}^{T} {p}_{θ} ( {x}_{t - 1} \vert {x}_{t} ) \qquad ( 2 )$$

where p(x_{T})=N(x_{T}; 0, I) is the pure noise distribution as the reverse process takes the outcome of the forward process, a sample of pure noise, as input and

$${\prod }_{t - 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and k represents the generated item with high quality. Diffusion process is an example of, or includes aspects of, the corresponding element described with reference to FIGS. 2, 4, 5, and 10-12.

Accordingly, an apparatus for image processing is described. One or more aspects of the apparatus include at least one processor; at least one memory component coupled with the at least one processor; and a multi-modal machine learning model comprising parameters stored in the at least one memory component, wherein the multi-modal machine learning model comprises a text encoder trained to encode an input text and an image encoder trained to encode an input image, and wherein the multi-modal machine learning model is trained based on a filtered training set that is obtained by comparing an alignment score of a training pair to an alignment score threshold.

In some aspects, the text encoder comprises a transformer model. In some aspects, the image encoder comprises a convolutional neural network. Some examples of the apparatus, system, and method further include an image decoder configured to generate an output image based on the input text. In some aspects, the image decoder comprises a denoising diffusion model. Some examples of the apparatus, system, and method further include a text decoder configured to generate an output text based on the input image. In some aspects, the text decoder comprises a transformer model.

### Image Generation Process

The present disclosure describes systems and methods for image generation. Embodiments of the present disclosure include a multi-modal machine learning model comprising a text encoder and an image decoder. In some examples, the multi-modal machine learning model receives an input text from a user. In some cases, the input text describes a scene, i.e., aspects of an element or a plurality of elements that the user wants to depict in the generated image. The multi-modal machine learning model encodes the received text, generates a set of images that describe the text, ranks the generated images based on their alignment to the text, and provides the image with the maximum alignment to the user.

Additionally or alternatively, the present disclosure describes systems and methods for text generation. Embodiments of the present disclosure include a multi-modal machine learning model comprising an image encoder and a text decoder. In some examples, the multi-modal machine learning model receives an input image from a user. In some cases, the input image depicts a scene, i.e., aspects of an element or a plurality of elements that the user wants to describe in the generated text. The multi-modal machine learning model encodes the received image, generates a set of text descriptions, and provides the description that accurately describes the image to the user.

FIG. 7 shows an example of a method 700 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Embodiments of the present disclosure are configured to perform an image-text alignment. In some cases, a multi-modal machine learning model of the present disclosure is configured to generate an output text that describes an input image. The multi-modal machine learning model, as described herein, is trained based on a training set (such as the training set described with reference to FIG. 9). In some cases, the training set comprises a training image, a positive training caption, and a negative training caption generated based on the positive training caption.

According to an embodiment, the multi-modal machine learning model of the present disclosure performs a filtering of the training set based on degree of alignment of the training caption and the training image. Accordingly, in some cases, the multi-modal machine learning model is configured to determine an alignment between an image and a text (e.g., a caption) based on training using the negative captions. Further details regarding generation of the negative training captions are provided with reference to FIGS. 7-9.

At operation 705, the system obtains an input image. In some cases, the operations of this step refer to, or may be performed by, a multi-modal machine learning model as described with reference to FIGS. 13 and 14. In some cases, the input image includes a first element having a first value of an attribute and a second element having a second value of the attribute. For example, the attribute could be ‘color’ and the image could depict an orange cat sleeping on a red car. Thus, the first value of the attribute could be ‘orange’ and the second value of the attribute could be ‘red’.

In some cases, a user interface of the multi-modal machine learning model (such as machine learning model 1315 described with reference to FIG. 13 or machine learning model 1400 described with reference to FIG. 14) receives an input image from a user. In some examples, the image processing apparatus receives the input image from the user or database or any other data source.

At operation 710, the system encodes, using an image encoder of a multi-modal machine learning model, the input image to obtain an image embedding. In some cases, the operations of this step refer to, or may be performed by, an image encoder as described with reference to FIG. 14. The image embedding can include a representation of the first element having the first value of the attribute and the second element having the second value of the attribute in a high-dimensional vector spate (i.e., tens or hundreds of dimensions).

At operation 715, the system generates, using a text decoder of the multi-modal machine learning model, an output text based on the image embedding. The output text indicates that the first element has the first value of the attribute and that the second element has the second value of the attribute. For example, the output could be a caption such as “an orange cat sleeping on a red car”, or a response to a query indicating that the picture includes an orange cat sleeping on a red car.

In some cases, the multi-modal machine learning model is trained based on a filtered training set that is obtained by comparing an alignment score of a training pair to an alignment score threshold. In some cases, the operations of this step refer to, or may be performed by, a text decoder as described with reference to FIG. 14.

According to an embodiment of the present disclosure, multi-modal machine learning model (such as multi-modal machine learning model described with reference to FIGS. 8-9 and 13-14) comprises an image encoder and a text decoder. In some cases, the image encoder is configured to encode the image into an image embedding. Additionally, the machine learning model comprising the text decoder is trained to predict an output text, i.e., the machine learning model is trained based on a filtered training dataset.

In some cases, the multi-modal machine learning model is configured to generate and use a negative caption during the training process (such as the training process described with reference to FIG. 9) for assessment of the image-text alignment. The multi-modal machine learning model is trained based on a positive image-text training pair. In some cases, the machine learning model uses a transformer model to generate a negative caption, e.g., using a replacement and swapping operation.

The multi-modal machine learning model is configured to generate a negative caption based on the positive training caption based on the replacement and swapping operations. In some examples, the replacement operation is configured to modify a caption element, such as modifying “a broken down stop sign” to “a brand new stop sign”. In some examples, the swapping operation is configured to reorganize the original caption elements to generate a new caption, such as reorganizing “an airplane is flying in the blue sky” as “a blue airplane is flying in the sky”. Further details regarding the replacement and swapping operations is described with reference to FIG. 8.

In some cases, the multi-modal machine learning model is configured to identify and remove the positive and negative captions that exhibit clear bias to generate refined or filtered data, e.g., a distinct bias is exhibited in the distribution between positive and negative captions. Subsequently, the machine learning model is trained with the refined (or filtered) dataset which ensures an improved and effective training process. The machine learning model is thus able to predict an accurate output text (e.g., text caption) for the input image.

Accordingly, by generating negative captions based on the positive captions, embodiments are able to improve the training of the multi-modal machine learning model by enabling the multi-modal machine learning model to enhance an understanding of the language structure. Additionally, embodiments of the present disclosure include a binary text classifier configured to differentiate between the positive and negative captions, thereby revealing a bias in positive and negative caption generation and detecting inaccurate color-object interactions.

Embodiments of the present disclosure are configured to generate a negative caption. In some cases, the multi-modal machine learning model of the present disclosure implements a transformer model (e.g., GPT4) to transform a positive caption into a negative caption. Additionally, in some cases, the multi-modal machine learning model comprises a classifier configured to mitigate a bias in the distributions of positive captions and negative captions.

FIG. 8 shows an example of an image alignment process 800 according to aspects of the present disclosure. In one aspect, image alignment process 800 includes preliminary training data 805, text decoder 820, negative training text 825, alignment score threshold 830, and filtered training set 835.

In one aspect, preliminary training data 805 includes training image 810 and training text 815. In some cases, preliminary training data 805 consists of image-text pairs {I, Tₚ}, where I represents an image (such as training image 810) and Tₚ represents an associated positive caption (such as training text 815). An embodiment of the present disclosure is configured to generate a negative caption based on a positive caption. In some cases, since the negative caption is generated using the positive caption, the multi-modal machine learning model creates a challenging (e.g., a hard or unbiased) negative caption which enables an improved training process (such as the training process described with reference to FIG. 9).

Embodiments of the present disclosure are configured to generate a negative caption using a language model. Referring to FIG. 8, a first caption of the negative training text 825 and a second caption of the negative training text 825 are generated using text decoder 820. As shown in FIG. 8, the first caption (i.e., “An orange cat walking on a red car”) of the negative training text 825 is generated using a replacement operation. In some cases, the replacement operation identifies key components in a language and uses text decoder 820 to replace the component with a plausible substitute component.

In some cases, the replaced component is a linguistic part such as a noun, adjective, preposition, etc. As shown in FIG. 8, the first caption of the negative training text 825 is generated by replacing a component (e.g., “sleeping”) in training text 815 with another plausible component (e.g., “walking”). Similarly, for example, training text such as “a photo of a broken down stop sign” is replaced with “a photo of a brand new stop sign”. Additionally, for example, training text such as “a cute cat looking at a bird” is replaced with “a cute dog looking at a bird”.

Accordingly, by using negative captions that are similar to the positive captions, embodiments of the present disclosure are able to better train the multi-modal machine learning model. As such, the trained multi-modal machine learning model has improved language recognition capabilities.

Referring again to FIG. 8, the second caption of the negative training text 825 is generated using text decoder 820. As shown in FIG. 8, the second caption (i.e., “A red cat walking on an orange car”) of the negative training text 825 is generated using a swapping operation. In some cases, the swapping operation generates a new sentence by utilizing the original language components, resulting in the swapping of identical linguistic components (e.g., two or more linguistic components in training text 815 are swapped).

In some cases, the swapping operation includes segmenting the original positive sentence (such as training text 815) into a plurality of (e.g., key) components. Subsequently, the multi-modal machine learning model is configured to generate a new sentence with the said components (e.g., elements). For example, in case the input caption is “an airplane is flying in the blue sky”, text decoder 820 (such as GPT) is configured to identify the key components including “airplane”, “flying”, “blue”, and “sky”. The text decoder 820 generates a sentence such as “a blue airplane is flying in the sky”.

In some examples, a short caption (such as a caption with less words) may not include sufficient language elements to form a different sentence, i.e., a sentence with a different meaning. Additionally, the multi-modal machine learning model of the present disclosure is able to evaluate if the new sentence is logically consistent and meaningful. In some cases, an artifact from an incorrect construction in a negative caption results in distribution disparities between positive and negative captions. Therefore, the multi-modal machine learning model employs common sense and grammar to correctly construct a negative caption from a positive caption and perform an alignment of the distributions of positive and negative sentences and/or captions.

Additionally, the machine learning model establishes, in order to align the distributions of positive and negative captions, a unique distribution for each image-pair dataset. In some cases, when employing rule-based methods or prompting language models to generate negative captions, human preconceptions and a pre-trained model reflect biases resulting in negative captions that originate from a different distribution.

Accordingly, an embodiment of the present disclosure includes a blind text-only binary classifier that processes positive and negative captions without using an image. In some cases, the binary classifier is adept at distinguishing between negative and positive captions based on the text (e.g., based exclusively on the text), i.e., despite the coherence and logical structure of negative captions.

An exemplary embodiment of the present disclosure includes accurate predictions for the replace and swap data categories. For example, in a dataset with training text (such as training text 815), the text decoder 820 substitutes terms such as “boat” and “elephant” for a caption comprising “airplane” and “giraffe”, respectively. In some examples, the machine learning model converts training text such as “a large airplane sitting on top of an airfield” or “a group of giraffes that are standing in the grass” to negative captions (i.e., replace negative data) such as “a large boat sitting on top of an airfield” or “a group of elephants that are standing in the grass”, respectively. In such cases, the pattern enables a binary classifier to identify the captions as negative.

According to an exemplary embodiment, the binary classifier is able to identify a caption with colorful animals interacting with a black object as a negative caption. For example, the classifier identifies a negative caption such as “a red puppy carrying a black frisbee in its mouth” generated from a positive caption such as “a black puppy carrying a red frisbee in its mouth”. In some cases, such as a swap data, the negative caption is logically coherent and grammatically correct. In some cases, the top accurately predicted (or most accurately predicted) positive captions depict activities such as surfing and motorcycle riding, which align with the content style of the dataset.

In some cases, the presence of bias in the data can obstruct a model's ability to understand image structures and learn language compositions since the model relies solely on textual cues for making predictions. Therefore, embodiments of the present disclosure are configured to reduce data distribution differences by selectively removing data that is predicted with high confidence by a text decoder (such as text decoder 820).

An embodiment of the present disclosure is configured to perform a data filtering operation. Referring to FIG. 8, biased positive and negative captions (indicated using dotted circles or easy positive and easy negative data) are eliminated during data filtering based on an alignment score threshold 830. The data filtering process ensures that the remaining text data (such as that indicated by solid circles within the limits of the alignment score threshold 830) cannot be distinguished by a text classifier based solely on text information. In some cases, entropy of the text information within the dataset is maximized.

According to an embodiment, the multi-modal machine learning model is configured to perform a comprehensive reduction of bias in the dataset. For instance, the machine learning model organizes the dataset into N partitions. For each iteration, one partition is designated as the test set while the remaining N−1 partitions serve as the training set. In some examples, a pretrained BERT model is used as the binary classifier. In some examples, the BERT model is trained on the training set. Subsequently, the trained classifier is applied to the designated test set.

Next, the correctly predicted samples are ranked based on a confidence level of the classifier. In some cases, the top k % of the samples for both positive and negative class predictions are removed. The remaining data is retained as refined dataset and the process is repeated for each partition. As described herein, the data filtering method is applied to image-text alignment. However, embodiments are not limited thereto, and the data filtering method described herein may be applied to a multimodal data scenario where bias in one modality affects model training.

Referring again to FIG. 8, the unbiased data (such as indicated using solid circles or corresponding to hard samples) are used to fine-tune a vision-language model. In some cases, the vision language model is fine-tuned to enhance the language compositional understanding capabilities with respect to images. For instance, a large multimodal model that is capable of image and text understanding is used. In some examples, the large multimodal model is adapted for use as an image-text score calculator based on a prompt formatting (such as “Does this image I match the following caption T. Answer Yes or No directly”.

In some cases, the large multimodal model relies on a language model to generate subsequent words. Next, the logits associated with the responses “Yes” and “No” are extracted for the next word. The matching score is defined as:

$$\frac{{e}^{P ( Y e s \vert prompt )}}{{e}^{P ( Y e s \vert prompt )} + {e}^{P ( No \vert prompt )}} \qquad ( 3 )$$

In some cases, the large multimodal model is finetuned with the prompt formatting (as described herein) using curated data for performance enhancement. The labels “Yes” and “No” are assigned to positive and negative pairs, respectively. In some cases, the large multimodal model is finetuned using a cross-entropy loss function.

Accordingly, a method for image processing is described. One or more aspects of the method include obtaining an input image; encoding, using an image encoder of a multi-modal machine learning model, the input image to obtain an image embedding; and generating, using a text decoder of the multi-modal machine learning model, an output text based on the image embedding, wherein the multi-modal machine learning model is trained based on a filtered training set that is obtained by comparing an alignment score of a training pair to an alignment score threshold.

In some aspects, the input image depicts a scene and the output text describes the scene. Some examples of the method, apparatus, and non-transitory computer readable medium further include generating the output text comprises: autoregressively generating each word of the output text in sequential order. Some examples of the method, apparatus, and non-transitory computer readable medium further include encoding the input image comprises: performing a convolutional operation on the input image to obtain the image embedding.

Some examples of the method, apparatus, and non-transitory computer readable medium further include obtaining an input text. Some examples further include generating, using an image decoder of the multi-modal machine learning model, an output image based on the input text.

### Training

Embodiments of the present disclosure provide a multi-modal machine learning model configured to perform image-text alignment. In some cases, the multi-modal machine learning model is configured to generate a training dataset for the image-text alignment. According to an embodiment of the present disclosure, the multi-modal machine learning model is configured to receive a training set including a training image and a training caption. In some cases, the training caption is a positive caption. In some cases, the multi-modal machine learning model is configured to generate a mixed-type training negative caption based on modifying the positive training caption.

In some cases, the image processing apparatus of the present disclosure enables a consistency between positive and negative caption distributions, thereby ensuring that the machine learning model relies on both image and text to measure alignment between the image and the text. According to an embodiment, the image processing apparatus is configured to generate a training data set for performing a finetuning process (such as the finetuning process described with reference to FIG. 9) for image-text alignment. In some cases, the image-text alignment process includes a ranking of the generated images (such as the rankings generated in operation 215 in FIG. 2).

Accordingly, by generating a training negative caption using the positive training caption, embodiments of the present disclosure are able to reduce the distribution imbalance between positive and negative captions and ensure that the multi-modal machine learning model does not depend solely on textual information but also considers the associated images for accurately predicting image-text alignment. Additionally, by enhancing the training data (i.e., incorporating unbiased positive training data and generating negative training data based on the positive training data), the multi-modal machine learning model exhibits improved capabilities of performing image-text alignment.

FIG. 9 shows an example of a method 900 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains preliminary training data including a positive training pair including a training image that depicts a scene and a training text that describes the scene. In some cases, the operations of this step refer to, or may be performed by, a multi-modal machine learning model as described with reference to FIGS. 13 and 14.

According to an embodiment, the preliminary training data comprises image-text training pairs. In some cases, each image-text training pair includes a training image and an associated positive training caption. A text decoder (such as text decoder 820 described in FIG. 8 and text decoder 1420 described in FIG. 14) is used to generate a negative training caption using the positive training caption based on a replacement or a swapping operation (such as the replacement and swapping operations described with reference to FIG. 8).

For example, a positive training caption associated with a training image describes “An orange cat sleeping on a red car”. A first negative training caption generated using the positive training caption based on the replacement operation is “An orange cat walking on a red car”. Additionally, the text decoder generates a second negative training caption using the positive training caption based on the swapping operation as “A red cat is walking on an orange car”. Further details regarding each of the replacement and swapping operations are provided with reference to FIG. 8.

At operation 910, the system filters the preliminary training data based on an alignment score threshold to obtain a filtered training set, where the preliminary training data is filtered by comparing an alignment score of the positive training pair to the alignment score threshold. In some cases, the operations of this step refer to, or may be performed by, a multi-modal machine learning model as described with reference to FIGS. 13 and 14.

In some cases, the multi-modal machine learning model is fine-tuned to enhance language compositional understanding capabilities with respect to images. In some cases, the multi-modal machine learning model removes biased (e.g., or straightforward or easy) positive and negative captions. For instance, referring to FIG. 8, the multi-modal machine learning model filters positive and negative captions that are beyond the alignment score threshold 830. Therefore, the filtered training set (such as filtered training set 835) obtained after removing the biased positive and negative captions is indicated as solid circles within the limits of the alignment score threshold 830.

According to an embodiment, the multi-modal machine learning model is used to compute an alignment score of the image-caption training pair (such as training image and positive training caption pair). In some cases, the multi-modal machine learning model uses a prompt formatting such as “Does this image I match the following caption T. Answer Yes or No directly” for computation of the alignment score. Additionally, the text decoder is used to generate a subsequent word based on manually extracting the logits associated with the responses “Yes” and “No” for the next word. In some cases, the alignment score is given as:

$$\frac{{e}^{P ( Y e s \vert prompt )}}{{e}^{P ( Y e s \vert prompt )} + {e}^{P ( No \vert prompt )}} \qquad ( 4 )$$

At operation 915, the system trains, using the filtered training set, the multi-modal machine learning model to encode the training image and the training text. In some cases, the operations of this step refer to, or may be performed by, a training component as described with reference to FIG. 13.

A training component (such as training component 1325 described with reference to FIG. 13) trains the multi-modal machine learning model using the filtered training data obtained at operation 910. The trained multi-modal machine learning model is then used to generate an image that aligns with an input text. Additionally or alternatively, the trained multi-modal machine learning model is then used to generate a text that aligns with an input image. Further details regarding generation of the text that aligns with the input image are provided with reference to FIG. 7.

Accordingly, embodiments of the present disclosure are configured to generate a diversity of negative captions using a positive caption. In some cases, the multi-modal machine learning model is configured to filter or remove a biased positive and a biased negative caption. In some cases, by filtering the biased captions, embodiments of the present disclosure are able to reduce data distribution discrepancies.

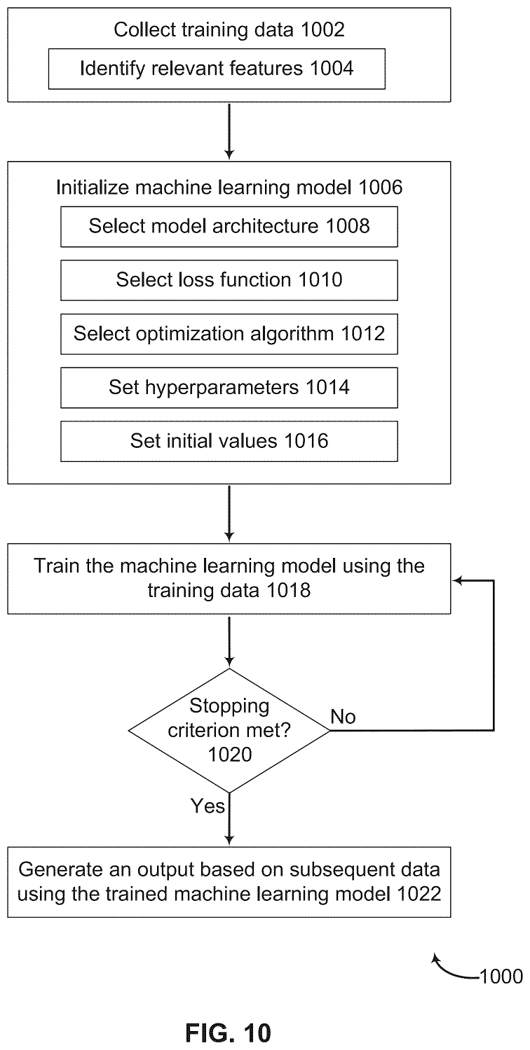

FIG. 10 shows an example of a method of training a machine learning model according to aspects of the present disclosure. FIG. 10 is a flow diagram depicting an algorithm as a step-by-step procedure 1000 in an example implementation of operations performable for training a machine-learning model. In some embodiments, the procedure 1000 describes an operation of the training component 1325 described for configuring the machine learning model 1315 as described with reference to FIG. 13. The procedure 1000 provides one or more examples of generating training data, use of the training data to train a machine-learning model, and use of the trained machine-learning model to perform a task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore once trained is configured to perform that task based on subsequent data received as an input and processed by the machine-learning model. The machine learning model or the multi-modal machine learning model, is an example of, or includes aspects of, the corresponding element described with reference to FIGS. 2, 4-6, 11, and 12.

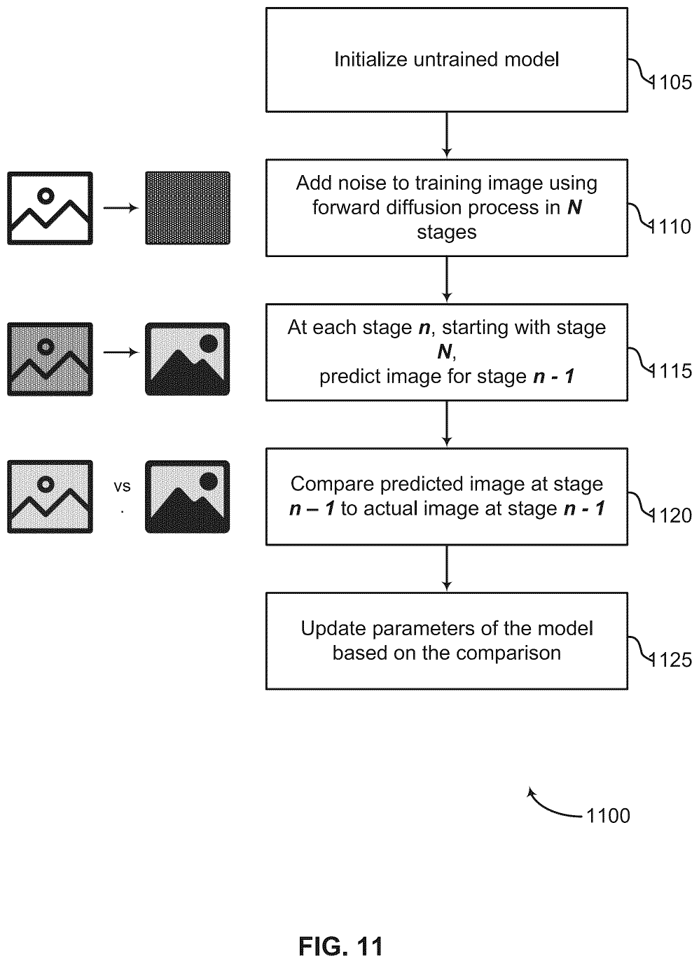

FIG. 11 shows an example of a method of training a diffusion model 1100 according to aspects of the present disclosure. In some embodiments, the method 1100 describes an operation of the training component 1325 described for configuring the multi-modal machine learning model 1315 as described with reference to FIG. 13. The method 1100 represents an example for training a reverse diffusion process as described above with reference to FIGS. 5-6. In some examples, these operations are performed by a system including a processor executing a set of codes to control functional elements of an apparatus, such as the guided diffusion model described in FIG. 4.

Additionally or alternatively, certain processes of method 1100 may be performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 11, according to some aspects, a training component (such as the training component 1325 described with reference to FIG. 13) trains a diffusion model (such as the multi-modal machine learning model described with reference to FIGS. 7-9) to generate an image.

At operation 1105, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1110, the system adds noise to a training image (or an additional training image) using a forward diffusion process (such as the forward diffusion process described with reference to FIG. 4) in N stages. In some cases, the operations of this step refer to, or may be performed by, a training component as described with reference to FIG. 13.

At operation 1115, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1120, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1125, the system updates parameters of the model based on the comparison. For example, parameters of a U-Net may be updated using gradient descent. Time-dependent parameters of the Gaussian transitions can also be learned.

Accordingly, a method for image processing is described. One or more aspects of the method include obtaining preliminary training data including a positive training pair comprising a training image that depicts a scene and a training text that describes the scene; filtering the preliminary training data based on an alignment score threshold to obtain a filtered training set, wherein the preliminary training data is filtered by comparing an alignment score of the positive training pair to the alignment score threshold; and training, using the filtered training set, the multi-modal machine learning model to encode the training image and the training text.

In some aspects, the alignment score threshold comprises a decision threshold between positive training pairs and negative training pairs, and wherein the filtering removes at least one training pair from the preliminary training data that is beyond a predetermined distance from the alignment score threshold. In some aspects, the preliminary training data includes a negative training pair comprising the training image and a negative training text describing a scene different from the scene depicted in the training image.

Some examples of the method, apparatus, and non-transitory computer readable medium further include generating the negative training text by modifying the training text. Some examples of the method, apparatus, and non-transitory computer readable medium further include encoding the training image and the training text to obtain an image embedding and a text embedding, respectively, wherein the alignment score of the positive training pair is based on a comparison of the image embedding and the text embedding.

Some examples of the method, apparatus, and non-transitory computer readable medium further include training the multi-modal machine learning model further comprises: computing a contrastive learning loss based on the positive training pair. Some examples further include iteratively updating the parameters stored in the non-transitory computer-readable medium based on the contrastive learning loss.

Some examples of the method, apparatus, and non-transitory computer readable medium further include obtaining an input image. Some examples further include generating, using the multi-modal machine learning model, an output text based on the input image.

Some examples of the method, apparatus, and non-transitory computer readable medium further include obtaining an input text. Some examples further include generating, using the multi-modal machine learning model, an output image based on the input text.

### Implementation and Evaluation

An exemplary embodiment of the present disclosure is configured to evaluate the large multimodal model based on a baseline model across a dataset. In some cases, an ablation study is conducted to evaluate the impact of the generation of negative captions for reducing data distribution discrepancies. In some cases, the multimodal model is evaluated against a baseline multimodal model.

For example, the baseline multimodal models include, but are not limited to, LLaVA-1.5, CLIP-ViT-L/14, BLIP-2, etc. In some examples, the multimodal model of the present disclosure is evaluated on image datasets (such as Winoground, SeeTRUE, MagicBrush, etc.). In some cases, a dataset is selected that provides positive image-text pairs. In some cases, a subset of the training images is incorporated from a benchmark dataset that combines multiple sources which enables diversification of the image dataset and enhancement of the robustness of the multi-modal machine learning model. Additionally, the machine learning model is used to generate negative data using swap and replace operations (as described with reference to FIG. 8) followed by performing random sampling to maintain an equal amount of positive and negative data.

For example, LLaVA-1.5 is refined for the model development using the generated and filtered data. Further, the model is trained with a batch size of 64 on 8 NVIDIA A100 GPUs for a single epoch. The learning rate is set at 2e-6. For example, in case of the data filtering operation, k is used as 30% and N is 5. The fine-tuned multi-modal model substantially enhances reasoning capabilities which indicates the importance of data filtering for data distribution. The fine-tuned multi-modal model shows significant improvement on synthetic image benchmark datasets.

According to an exemplary embodiment, the multi-modal model is used to generate different types of datasets. In some cases, the text decoder is prompted to generate scenarios including attribute binding, object counting, and spatial relationships that guide the generation process. In some examples, a text-to-image model is used to generate 50 images for each prompt from which one positive and one negative image is manually selected based on image-text alignment. Synthetic images are used due to increased flexibility. In some cases, synthetic images incorporate diverse styles (e.g., painting styles for birds), create unconventional images (e.g., the examples involving soccer and cats), and has attribute/object merging capabilities of text-to-image models to enhance the dataset with varied negative cases.

An exemplary embodiment of the present disclosure include computation of classification accuracy. In some cases, the classification accuracy is used as a metric with positive and negative results. In some examples, the baseline models are categorized as two groups, i.e., models that generate scores without an established classification threshold and models that operate with a decision boundary for classification.

According to an exemplary embodiment of the present disclosure, the multi-modal machine learning model is able to significantly enhance the performance of image-text alignment based on replace and swap data for different evaluated datasets. Additionally, the data filtering process reduces the amount of data which shows that combination of the replace and swap operations has significantly high performance for datasets such as Winoground and SugarCrepe.

An exemplary embodiment of the present disclosure evaluates the impact of removing a set of biased data on the performance of the multi-modal machine learning model on a plurality of datasets. For example, removal of top k % of the biased data, where k varies between 0 to 90 indicates that as the biased data is progressively removed, performance improves, performance peaking at approximately 30% to 40%.

In some cases, a text-only classifier is used to mitigate the bias arising from distribution discrepancies between positive and negative captions. In some examples, a dataset is divided into five equally sized partitions. For each iteration, four partitions if the five equally sized partitions are employed as a training set and the fifth partition employed as test set. The iterations are performed till every partition is used as the test set. For example, the fine-tuning parameters for the DistilBERT classifier are set to a learning rate of 2e-5 and a batch size of 16, over a duration of three epochs. The classifier is applied to the test set to identify and filter biased data, based on the prediction confidence of the classifier. Additionally, for example, the fine-tuning of the parameters of BLIP2 are performed using a batch size of 128 and a learning rate of 1e-5, across 1000 steps.

In some examples, MagicBrush consists of quartets that include one original image Iₒᵣᵢ, one edited image I_{edt}, and their respective captions Cₒᵣᵢ and C_{edt}. The text score and image score are defined as:

$$f ( {C}_{ori} , {I}_{ori} , {C}_{edt} , {I}_{edt} ) = \{ \begin{matrix}1 & if s ( {C}_{ori} , {I}_{ori} ) > s ( {C}_{edt} , {I}_{ori} ) \\ 0 & otherwise\end{matrix} \qquad ( 5 )$$

$$and$$

$$g ( {C}_{ori} , {I}_{ori} , {C}_{edt} , {I}_{edt} ) = \{ \begin{matrix}1 & if s ( {C}_{ori} , {I}_{ori} ) > s ( {C}_{edt} , {I}_{ori} ) \\ 0 & otherwise\end{matrix} \qquad ( 6 )$$

where s(C, I) represents the scoring function used to evaluate the alignment between a text-image pair. The group score is defined as:

$$h ( {C}_{ori} , {I}_{ori} , {C}_{edt} , {I}_{edt} ) = \{ \begin{matrix}1 & if f ( {C}_{ori} , {I}_{ori} , {C}_{edt} , {I}_{edt} ) and g ( {C}_{ori} , {I}_{ori} , {C}_{edt} , {I}_{edt} ) \\ 0 & otherwise\end{matrix} \qquad ( 7 )$$

Note that each of s(Cₒᵣᵢ, Iₒᵣᵢ)>s(C_{edt}, Iₒᵣᵢ) for test score and s(Cₒᵣᵢ, Iₒᵣᵢ)>s(Cₒᵣᵢ, I_{edt}) for image score may vary. In some cases, since the original image caption Cₒᵣᵢ aligns with the edited image I_{edt}, the model is not penalized for assigning a high score to s(Cₒᵣᵢ, I_{edt}).

According to an embodiment, a custom dataset is curated to focus on the attribute, counting, and spatial reasoning capabilities of the machine learning model. In some cases, the dataset is generated based on creating captions using a text decoder and selecting an image that aligns with the caption (positive sample) and an image that does not align with the caption (negative sample).

The present disclosure describes systems and methods for generating training data for an image-text alignment model. In some cases, embodiments include generation of a large scale dataset (such as ground truth positive captions for images). Additionally, embodiments are able to generate challenging negative captions for enhancing the training process for the image-text alignment model. In some cases, a challenging negative caption is obtained based on a filtering of the biased negative samples.

### Computing Device

FIG. 12 shows an example of a computing device according to aspects of the present disclosure. The computing device 1200 may be an example of the image processing apparatus 1300 described with reference to FIG. 13. In one aspect, computing device 1200 includes processor(s) 1205, memory subsystem 1210, communication interface 1215, I/O interface 1220, user interface component(s) 1225, and channel 1230.

In some embodiments, computing device 1200 is an example of, or includes aspects of, the machine learning model of FIG. 14. In some embodiments, computing device 1200 includes one or more processors 1205 that can execute instructions stored in memory subsystem 1210 to perform media generation.

According to some aspects, computing device 1200 includes one or more processors 1205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1220 or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote-control device interfaced with a user interface directly or through the I/O controller), or a combination thereof. In some cases, user interface component(s) 1225 include a GUI.

FIG. 13 shows an example of an image processing apparatus 1300 according to aspects of the present disclosure. According to some aspects, image processing apparatus 1300 obtains an input image. In some examples, image processing apparatus 1300 obtains an input prompt. In some embodiments, image processing apparatus 1300 includes processor unit 1305, memory unit 1310, machine learning model 1315, I/O module 1320, and training component 1325. Training component 1325 updates parameters of the machine learning model 1315 stored in memory unit 1310. In some examples, the training component 1325 is located outside the image processing apparatus 1300.

Processor unit 1305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1305 is configured to operate a memory array using a memory controller. In other cases, a memory controller is integrated into processor unit 1305. In some cases, processor unit 1305 is configured to execute computer-readable instructions stored in memory unit 1310 to perform various functions. In some aspects, processor unit 1305 includes special purpose components for modem processing, baseband processing, digital signal processing, or transmission processing. According to some aspects, processor unit 1305 comprises one or more processors described with reference to FIG. 12.

Memory unit 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1305 to perform various functions described herein.

In some cases, memory unit 1310 includes a basic input/output system (BIOS) that controls basic hardware or software operations, such as an interaction with peripheral components or devices. In some cases, memory unit 1310 includes a memory controller that operates memory cells of memory unit 1310. For example, the memory controller may include a row decoder, column decoder, or both. In some cases, memory cells within memory unit 1310 store information in the form of a logical state. According to some aspects, memory unit 1310 is an example of the memory subsystem 1210 described with reference to FIG. 12.

According to some aspects, image processing apparatus 1300 uses one or more processors of processor unit 1305 to execute instructions stored in memory unit 1310 to perform functions described herein. For example, the image processing apparatus 1300 may obtain an input image; encode, using an image encoder of a multi-modal machine learning model, the input image to obtain an image embedding; and generate, using a text decoder of the multi-modal machine learning model, an output text based on the image embedding, wherein the multi-modal machine learning model is trained based on a filtered training set that is obtained by comparing an alignment score of a training pair to an alignment score threshold.

The memory unit 1310 may include a machine learning model 1315 trained to obtain an input image; encode, using an image encoder of a multi-modal machine learning model, the input image to obtain an image embedding; and generate, using a text decoder of the multi-modal machine learning model, an output text based on the image embedding, wherein the multi-modal machine learning model is trained based on a filtered training set that is obtained by comparing an alignment score of a training pair to an alignment score threshold. For example, after training, the machine learning model 1315 may perform inferencing operations as described with reference to FIGS. 1-3 to obtain an input image; encode, using an image encoder of a multi-modal machine learning model, the input image to obtain an image embedding; and generate, using a text decoder of the multi-modal machine learning model, an output text based on the image embedding, wherein the multi-modal machine learning model is trained based on a filtered training set that is obtained by comparing an alignment score of a training pair to an alignment score threshold.

In some embodiments, the machine learning model 1315 is an Artificial neural network (ANN) such as the guided diffusion model described with reference to FIG. 1 and the U-Net described with reference to FIG. 2. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 1315 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1325 may train the machine learning model 1315. For example, parameters of the machine learning model 1315 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 10). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1315 can be used to make predictions on new, unseen data (i.e., during inference).

According to some aspects, multi-modal machine learning model 1315 obtains preliminary training data including a positive training pair including a training image that depicts a scene and a training text that describes the scene. In some examples, multi-modal machine learning model 1315 filters the preliminary training data based on an alignment score threshold to obtain a filtered training set, where the preliminary training data is filtered by comparing an alignment score of the positive training pair to the alignment score threshold. In some aspects, the alignment score threshold includes a decision threshold between positive training pairs and negative training pairs, and where the filtering removes at least one training pair from the preliminary training data that is beyond a predetermined distance from the alignment score threshold.

In some aspects, the preliminary training data includes a negative training pair including the training image and a negative training text describing a scene different from the scene depicted in the training image. In some examples, multi-modal machine learning model 1315 encodes the training image and the training text to obtain an image embedding and a text embedding, respectively, where the alignment score of the positive training pair is based on a comparison of the image embedding and the text embedding. In some examples, multi-modal machine learning model 1315 obtains an input image. In some examples, multi-modal machine learning model 1315 obtains an input text.

According to some aspects, multi-modal machine learning model 1315 obtains an input image. In some aspects, the input image depicts a scene and the output text describes the scene. In some examples, multi-modal machine learning model 1315 obtains an input text.

According to some aspects, multi-modal machine learning model 1315 is comprising parameters stored in the at least one memory component, wherein the multi-modal machine learning model 1315 comprises a text encoder trained to encode an input text and an image encoder trained to encode an input image, and wherein the multi-modal machine learning model 1315 is trained based on a filtered training set that is obtained by comparing an alignment score of a training pair to an alignment score threshold. Multi-modal machine learning model 1315 is an example of, or includes aspects of, the corresponding element described with reference to FIG. 14.

I/O module 1320 receives inputs from and transmits outputs of the natural language processing apparatus 1300 to other devices or users. For example, I/O module 1320 receives inputs for the machine learning model 1315 and transmits outputs of the machine learning model 1315. According to some aspects, I/O module 1320 is an example of the I/O interface 1220 described with reference to FIG. 12.

According to some aspects, training component 1325 trains, using the filtered training set, the multi-modal machine learning model 1315 to encode the training image and the training text. In some examples, training component 1325 trains the multi-modal machine learning model 1315 further includes: computing a contrastive learning loss based on the positive training pair. In some examples, training component 1325 iteratively updates the parameters stored in the non-transitory computer-readable medium based on the contrastive learning loss.

FIG. 14 shows an example of a multi-modal machine learning model 1400 according to aspects of the present disclosure. Multi-modal machine learning model 1400 is an example of, or includes aspects of, the corresponding element described with reference to FIG. 13. In one aspect, multi-modal machine learning model 1400 includes image encoder 1405, image decoder 1410, text encoder 1415, and text decoder 1420.

According to some aspects, image encoder 1405 of a multi-modal machine learning model 1400 encodes the input image to obtain an image embedding. In some examples, image encoder 1405 encodes the input image including performing a convolutional operation on the input image to obtain the image embedding.

An “embedding” refers to a representation of an object (e.g., the text prompt) in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar to and thus “closer” to each other, thereby allowing a similarity between different objects corresponding to different embeddings to be readily determined. A “text embedding” refers to an embedding of the text prompt, e.g., a representation of the text prompt in an embedding space.

An “embedding space” (or a “vector space”) refers to a set having embeddings (or vectors) as elements, and is characterized by a dimension specifying a number of independent directions in the embedding space. According to some aspects, the embedding space is a multi-modal embedding space that is shared by text embeddings and image embeddings, such that a text embeddings and an image embedding may be compared with each other.

In some aspects, the image encoder 1405 includes a convolutional neural network. A convolutional neural network (CNN) is a class of neural network that is commonly used in computer vision or image classification systems. In some cases, a CNN may enable processing of digital images with minimal pre-processing. A CNN may be characterized by the use of convolutional (or cross-correlational) hidden layers. The convolutional layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

According to some aspects, image decoder 1410 generates, using the multi-modal machine learning model 1400, an output image based on the input text. According to some aspects, image decoder 1410 is configured to generate an output image based on the input text. In some aspects, the image decoder 1410 includes a denoising diffusion model.

In some aspects, the text encoder 1415 includes a transformer model. According to some aspects, text decoder 1420 generates the negative training text by modifying the training text. In some examples, text decoder 1420 generates, using the multi-modal machine learning model 1400, an output text based on the input image.

According to some aspects, text decoder 1420 of the multi-modal machine learning model 1400 generates an output text based on the image embedding, where the multi-modal machine learning model 1400 is trained based on a filtered training set that is obtained by comparing an alignment score of a training pair to an alignment score threshold. In some examples, text decoder 1420 generates the output text including autoregressively generating each word of the output text in sequential order.

According to some aspects, text decoder 1420 is configured to generate an output text based on the input image. In some aspects, the text decoder 1420 includes a transformer model.

According to some aspects, a transformer comprises one or more ANNs comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures, particularly ANNs employed in natural language processing (NLP) and sequence-to-sequence tasks, which allows an ANN to focus on different parts of an input sequence when making predictions or generating output.

NLP refers to techniques for using computers to interpret or generate natural language. NLP tasks can involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features to express the relative probability of multiple answers.

Some sequence models process an input sequence sequentially, maintaining an internal hidden state that captures information from previous steps. However, this sequential processing can lead to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, comprising:
obtaining an input image including a first element having a first value of an attribute and a second element having a second value of the attribute;
encoding, using an image encoder of a multi-modal machine learning model, the input image to obtain an image embedding; and
generating, using a text decoder of the multi-modal machine learning model, an output text based on the image embedding, wherein the output text indicates that the first element has the first value of the attribute and that the second element has the second value of the attribute.

2. The method of claim 1, wherein:
the input image depicts a scene and the output text describes the scene.

3. The method of claim 1, wherein generating the output text comprises:
autoregressively generating each word of the output text in sequential order.

4. The method of claim 1, wherein encoding the input image comprises:
performing a convolutional operation on the input image to obtain the image embedding.

5. The method of claim 1, further comprising:
obtaining an input text; and
generating, using an image decoder of the multi-modal machine learning model, an output image based on the input text.

6. A method of training a multi-modal machine learning model, the method comprising:
obtaining preliminary training data including a positive training pair comprising a training image that depicts a scene and a training text that describes the scene;
filtering the preliminary training data based on an alignment score threshold to obtain a filtered training set including the positive training pair, wherein the preliminary training data is filtered by comparing an alignment score of the positive training pair to the alignment score threshold; and
training, using the filtered training set, the multi-modal machine learning model to encode the training image and the training text.

7. The method of claim 6, wherein the alignment score threshold comprises a decision threshold between positive training pairs and negative training pairs, and wherein the filtering removes at least one training pair from the preliminary training data that is beyond a predetermined distance from the alignment score threshold.

8. The method of claim 6, wherein the preliminary training data includes a negative training pair comprising the training image and a negative training text describing a scene different from the scene depicted in the training image.

9. The method of claim 8, further comprising:
generating the negative training text by modifying the training text.

10. The method of claim 6, further comprising:
encoding the training image and the training text to obtain an image embedding and a text embedding, respectively, wherein the alignment score of the positive training pair is based on a comparison of the image embedding and the text embedding.

11. The method of claim 6, wherein training the multi-modal machine learning model further comprises:
computing a contrastive learning loss based on the positive training pair; and
iteratively updating parameters of the multi-modal machine learning model based on the contrastive learning loss.

12. The method of claim 6, further comprising:
obtaining an input image; and
generating, using the multi-modal machine learning model, an output text based on the input image.

13. The method of claim 6, further comprising:
obtaining an input text; and
generating, using the multi-modal machine learning model, an output image based on the input text.

14. A system for image processing, comprising:
a memory component; and
a processing device coupled to the memory component, the processing device configured to perform operations comprising:
obtaining an input image;
encoding, using an image encoder of a multi-modal machine learning model, the input image to obtain an image embedding; and
generating, using a text decoder of the multi-modal machine learning model, an output text based on the image embedding, wherein the multi-modal machine learning model is trained based on a filtered training set that is obtained by comparing an alignment score of a training pair to an alignment score threshold.

15. The system of claim 14, wherein the text encoder comprises a transformer model.

16. The system of claim 14, wherein the image encoder comprises a convolutional neural network.

17. The system of claim 14, further comprising:
an image decoder configured to generate an output image based on the input text.

18. The system of claim 17, further comprising:
the image decoder comprises a denoising diffusion model.

19. The system of claim 14, further comprising:
a text decoder configured to generate an output text based on the input image.

20. The system of claim 19, wherein the text decoder comprises a transformer model.
